(19) United States
(12) Patent Application Publication
(10) Pub. No.: US 2023/0421854 A1
(43) Pub. Date: Dec. 28, 2023

(54) IMAGE REPRODUCTION SYSTEM AND IMAGE REPRODUCTION METHOD

(71) Applicant: IRUDA PLANET INC, Daejeon (KR)

(72) Inventor: Hyung Sik KIM, Daejeon (KR)

(21) Appl. No.: 18/036,811

(22) PCT Filed: Nov. 12, 2021
(86) PCT No.: PCT/KR2021/016506

§ 371 Date: May 12, 2023

(30) Foreign Application Priority Data
Nov. 13, 2020 (KR) 10-2020-0152047
Dec. 4, 2020 (KR) 10-2020-0168697
Jan. 14, 2021 (KR) 10-2021-0005316

(51) Int. Cl. H04N 21/472; H04N 21/218; H04N 21/81

(52) U.S. Cl. CPC H04N 21/47217; H04N 21/21805; H04N 21/816

(57) ABSTRACT

An image reproduction system of the present invention comprises: a storage module in which images captured along a specific motion trajectory are stored; a display module which displays the images; an input module to which a signal corresponding to a user's operation is input; and a control module which displays the images by the display module according to the signal input to the input module.

### TECHNICAL FIELD

The present invention relates to a video playback system and a video playback method.

### RELATED ART

So far, a device that provide a video to a user has not allowed an active manipulation of the user in addition to playback, pause, or speed control.

Currently, devices and contents that provide users with sense of reality are rapidly increasing. However, since the users may not actively manipulate the videos, there is a limitation to the sense of reality.

Therefore, there is a need for a video playback system that allows a user to actively manipulate provided content and videos as desired.

### DETAILED DESCRIPTION

### Technical Subject

An objective of the present invention is to provide a video playback system and a video playback method that allow a user to actively manipulate provided content and videos as desired.

The aforementioned objects and other objects of the present invention may be achieved from the following present invention.

### Technical Solution

One aspect of the present invention relates to a video playback system.

According to an example embodiment, the video playback system includes a storage module configured to store a video captured along a specific movement line; a display module configured to display the video; an input module configured to receive a signal corresponding to a manipulation of a user; and a control module configured to play back the video on the display module in response to the signal input to the input module.

The video may be a video captured with a 360° camera.

The control module may switch between playback and reverse playback according to a specific signal input to the input module.

In another example embodiment, the video may include a first video and a second video, the second video may be a reverse playback video of the first video, and the control module may be configured to switch between playback of the first video and playback of the second video according to a specific signal input to the input module.

In still another example embodiment, the video may include the first video and the second video, and the second video may be a video captured in a reverse direction of the specific movement line.

The first video and the second video may be coupled and stored in the storage module.

Each of the first video and the second video may be captured while moving at the same speed.

The first video and the second video may be captured at substantially the same moving speed in a direction and a reverse direction of the specific movement line.

Video times of the first video and the second video may be converted to be substantially the same.

The first video and the second video may be matched at the same location in the specific movement line.

The matching may be matching based on playtimes of the first video and the second video.

The control module may switch between playback of the first video and playback of the second video at the matched same location according to a specific signal input to the input module.

The storage module may store the video with start point and end point information of the specific movement line, the control module may provide the user with information on a video of another specific movement line in which an end point of the specific movement line is stored as a start point after the video is displayed on the display module, and the control module may play back the video of the other specific movement line selected according to a selection signal input to the input module, on the display module.

In another example embodiment, the video may further include an end point video captured at a specific time in place after moving along the specific movement line.

The control module may play back the video of the other specific movement line selected according to the selection signal input to the input module on the display module during playback of the end point video.

Each of the first video and the second video may include at least two videos by changing at least one of weather, time, day and night, and moment, and videos having substantially the same weather, time, day and night, and moment may be coupled and stored in the storage module.

Another aspect of the present invention relates to a video playback method.

According to an example embodiment, the video playback method may include capturing a video along a specific movement line and storing the video in a storage module; displaying the video on a display module; receiving a signal corresponding to a manipulation of a user using an input module; and switching the video between playback and reverse playback according to the signal.

According to another example embodiment, the video playback method may include capturing a first video along a specific movement line and storing the first video in a storage module; transforming the video to reversely play back and storing the same as a second video in the storage module; playing back one of the first video and the second video on a display module; receiving a signal corresponding to a manipulation of a user using an input module; and switching between playback of the first video and playback of the second video according to the signal.

According to still another example embodiment, the video playback method may include capturing a first video along a specific movement line and storing the first video in a storage module; capturing a second video in a reverse direction of the specific movement line and storing the second video in the storage module; playing back one of the first video and the second video on a display module; receiving a signal corresponding to a manipulation of a user using an input module; and switching between playback of the first video and playback of the second video according to the signal.

At least one of the first video and the second video may further include an end point video captured at a specific time in place after moving along the specific movement line or in the reverse direction of the specific movement line.

### Effect

The present invention has the effect of providing a hollow fiber membrane with excellent mechanical strength and water permeability and a manufacturing method thereof.

### BRIEF DESCRIPTION OF DRAWINGS

FIG. 1 is a block diagram illustrating a video playback system according to an example embodiment of the present invention.

FIG. 2 illustrates an example of capturing a video along a specific movement line in a video playback system according to an example embodiment of the present invention.

FIG. 3 illustrates an example of an operation of a video playback system according to an example embodiment of the present invention.

FIG. 4 illustrates an example of a reverse playback video in a video playback system according to another example embodiment of the present invention.

FIG. 5 illustrates an example of an operation of a video playback system according to another example embodiment of the present invention.

FIG. 6 illustrates an example of a forward video and a backward video of a video playback system according to still another example embodiment of the present invention.

FIG. 7 illustrates an example of a video transformation in a video playback system according to still another example embodiment of the present invention.

FIG. 8 illustrates an example of an operation of a video playback system according to still another example embodiment of the present invention.

FIG. 9 illustrates an example of a relationship between one video and another video in a video playback system according to still another example embodiment of the present invention.

FIG. 10 illustrates an example of a video of a video playback system according to still another example embodiment of the present invention.

### MODE

Hereinafter, example embodiments of the present application will be described in detail with reference to the accompanying drawings. However, technology disclosed set forth herein may be implemented in another form without being limited to the example embodiments.

Here, the example embodiments are provided such that the disclosed contents may become thorough and complete and the spirit of the present application may be sufficiently conveyed to one skilled in the art. In the drawings, sizes of components, such as widths, thicknesses, etc., are slightly enlarged to clearly express components of each device. Also, although only some of the components are illustrated for clarity of description, one skilled in the art may easily verify remaining of the components.

When describing the drawings as a whole, the description is made from a point of view of an observer. When one component is described as being located above or below another component, it indicates that the one component is located directly above or below the other component or that an additional component may be interposed between the components. Also, one of ordinary skill in the art may implement the spirit of the present application in various other forms without departing from the technical spirit of the present application. Also, like reference numerals in the drawings refer to like elements throughout.

As used herein, the singular forms “a,” “an,” and “the” are intended to include the plural forms as well, unless the context clearly indicates otherwise and it will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Also, as used herein, “X to Y” representing the range indicates “X or more and Y or less.”

Herein, the term “portion” includes a unit implemented by hardware, a unit implemented by software, and a unit implemented using both. Also, a single unit may be implemented using two or more hardware and at least two units may be implemented using one hardware. Also, “˜portion” is not limited to software or hardware and may be configured to be present in an addressable storage medium or to reproduce one or more processors. Therefore, for example, “˜portion” includes components, such as software components, object-oriented software components, class components, and task components, processes, functions, attributes, procedures, sub-routines, segments of a program code, drivers, firmware, microcode, circuits, data, databases, data structures, tables, arrays, and variables. Functions provided within “˜portions” and the components may be combined into a smaller number of components and “˜portions” or may be further divided into addition components and “˜portions.” In addition, the components and “˜portions” may be implemented to reproduce one or more central processing units (CPUs) within a device or a secure multimedia card.

Also, “network” or “communication” may be implemented as a wired network, such as a local area network (LAN), a wide area network (WAN), and a value added network (VAN), or any types of wireless networks, such as a mobile radio communication network and a satellite communication network.

Herein, the term “start point (SP)” may represent a point at which a movement line starts and the term “end point” may represent a point at which the movement line ends. In the case of capturing a video in a reverse direction of the movement line, a “start point” in a forward direction may be an “end point” of the movement line in a reverse direction, and an “end point (EP)” in the forward direction” may be a “start point” of the movement line in the reverse direction.

### Video Playback Device

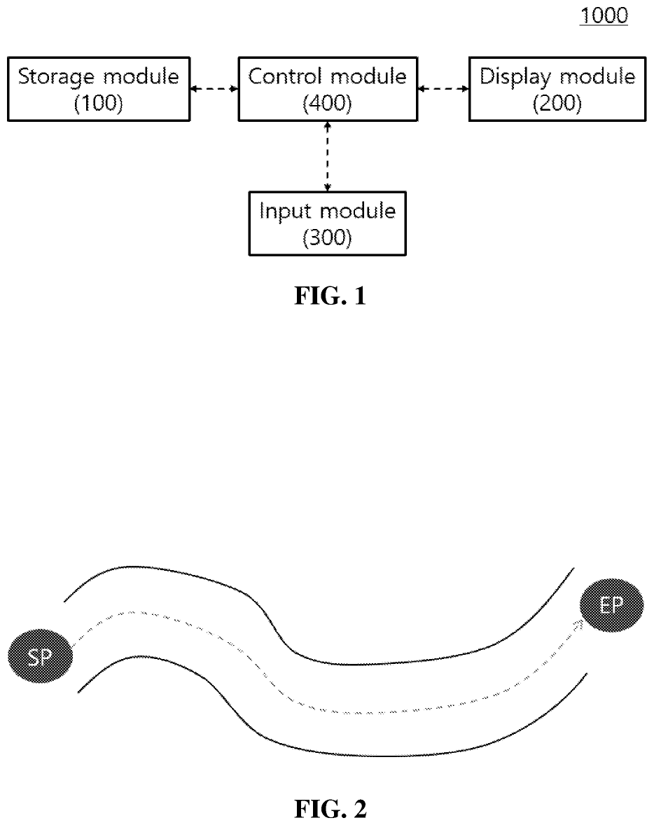

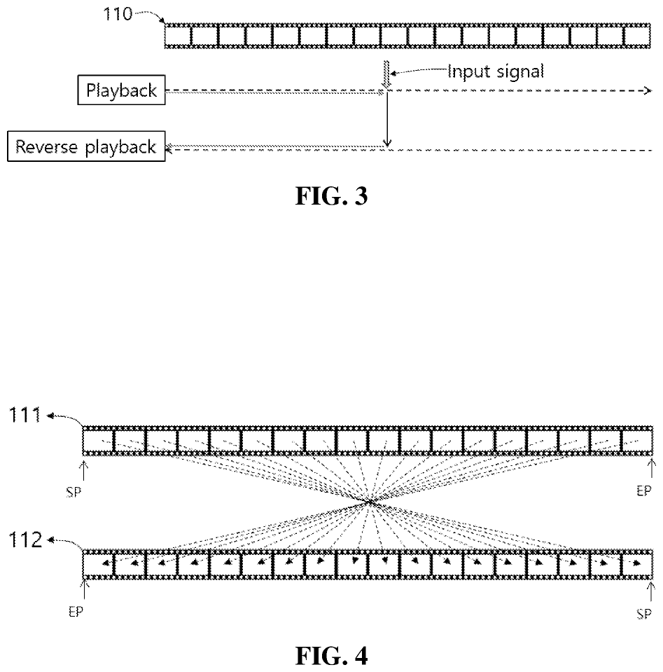

Hereinafter, a video playback device according to an example embodiment of the present invention is described with reference to FIGS. 1 to 3. FIG. 1 is a block diagram illustrating a video playback system according to an example embodiment of the present invention, FIG. 2 illustrates an example of capturing a video along a specific movement line in a video playback system according to an example embodiment of the present invention, and FIG. 3 illustrates an example of an operation of a video playback system according to an example embodiment of the present invention.

Referring to FIG. 1, a video playback system 1000 according to an example embodiment of the present invention includes a storage module 100 configured to store a video 110 captured along a specific movement line; a display module 200 configured to display the video 110; an input module 300 configured to receive a signal corresponding to a manipulation of a user; and a control module 400 configured to play back the video 110 on the display module 200 according to an input signal input to the input module.

The storage module 100 may store the video 110 captured in advance along the specific movement line. For example, referring to FIG. 2, the video 110 may be a video captured from a start point at which the specific movement line starts to an end point at which the specific movement line ends. The video 110 may be captured in advance with a capturing module (not shown) and may be stored in the storage module 100 through wired/wireless communication. In an example embodiment, the video 110 may be a video captured with a 360° camera.

If it is capable of display an image or a video, the display module 200 is not particularly limited and may further include a speaker capable of outputting sound in addition to displaying the image or the video and may include a device for 4D realization. In an example embodiment, the display module 200 may display the video stored in the storage module 100.

The input module 300 is configured to receive a signal corresponding to a manipulation of a user and may include various types of input devices and may include a virtual reality (VR)/augmented reality (AR)/mixed reality (MR) remote controller, a VR/AR/MR controller, and the like.

The control module 400 of the present invention may play back the video, for example, the video 110 stored in the storage module 100, on the display module 200 in response to the signal input to the input module 300.

In detail, referring to FIG. 3, the control module 400 may switch between playback and reverse playback according to a specific signal (input signal) input to the input module 300. Switching between the playback and the reverse playback may be performed at a point in time at which the specific signal (input signal) is input during playback and, in the case of a video that includes location movement, may provide the effect of allowing a user to go back.

Currently, various contents are being provided through VR/AR/MR. For example, in a VR implement device related to a road view or a street view, the user has no way but to view a video captured in advance from one fixed point to another fixed point at a time and has some inconvenience to return after viewing the entire video up to the other fixed point in order to go back on the road view or the street view. This causes inconvenience to the user and also provided content may be inevitably less realistic since the video is not played back according to the intent of the user.

In the video playback system of the present invention, the control module 400 switches between playback and reverse playback in response to a specific signal input to the input module 300, for example, a signal to go back. Therefore, the user may be free to actively change a direction and the sense of reality may be maximized. This does not cause any inconvenience to the user particularly in the case of providing a video (content) with a space with no or few persons.

In another example embodiment, referring to FIG. 4, the video 110 includes a first video 111 and a second video 112, the second video 112 may be a reverse playback video of the first video 111, and the control module 400 may switch between playback of the first video 111 and playback of the second video 112 according to a specific signal input to the input module 300. In an example embodiment, the control module 400 may transform the first video 111 to reversely play back and may store the same as the second video 112.

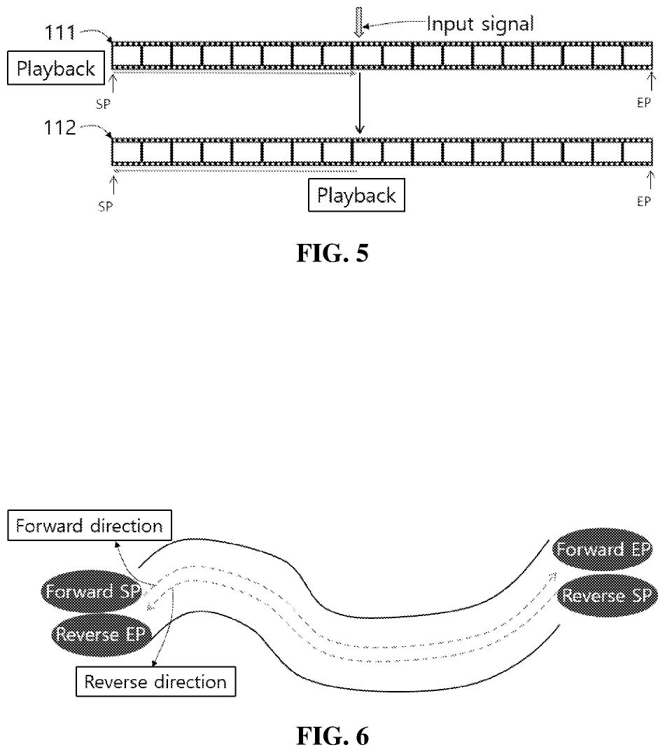

To describe a video playback system according to another example embodiment of the present invention, FIG. 5 illustrates the second video 112 to correspond to the first video 111 at the same location and the second video 112 is a video that is played back from right to left.

Referring to FIG. 5, in another example embodiment of the present invention, switching between playback of the first video 111 and playback of the second video 112 may be performed at a point in time at which a specific signal (input signal) is input during playback and, in the case of a video that includes a location movement, the effect that allows the user to go back may be provided.

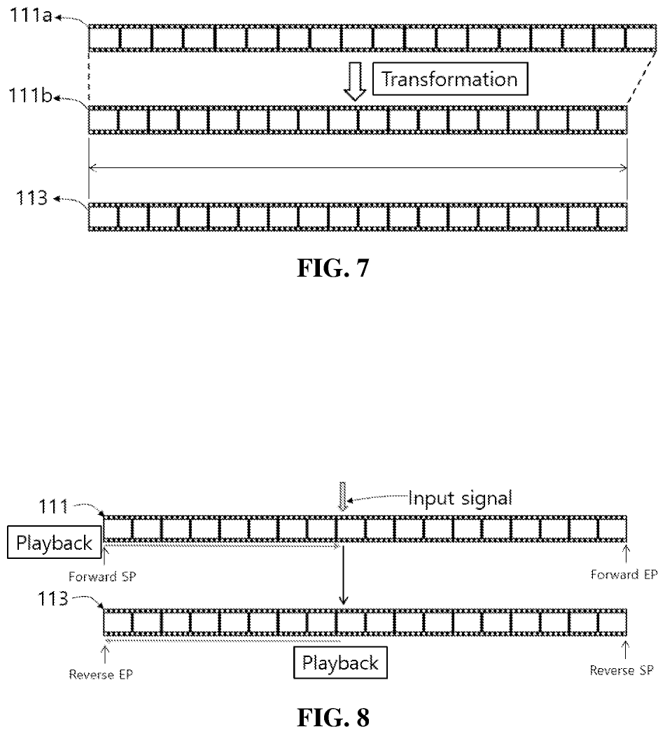

Hereinafter, a video playback system according to still another example embodiment of the present invention is described with reference to FIGS. 6 to 8. FIG. 6 illustrates an example of a forward video and a backward video of a video playback system according to still another example embodiment of the present invention, FIG. 7 illustrates an example of a video transformation in a video playback system according to still another example embodiment of the present invention, and FIG. 8 illustrates an example of an operation of a video playback system according to still another example embodiment of the present invention.

In still another example embodiment, referring to FIG. 6, in the video playback system, the video 110 may include the first video 111 and a second video 113, and the second video 113 may be a video captured in a reverse direction of the specific movement line. Here, the first video 111 may be defined as being captured in a forward direction. When a person or an animal is included in a video, reverse playback may not be appropriate. In still another example embodiment of the present invention, a more realistic video may be provided to the user by including the second video 113 captured in the reverse direction of the specific movement line.

To describe a video playback system according to still another example embodiment of the present invention, FIG. 8 illustrates the second video 113 that is a video captured in a reverse direction to correspond to the first video 111 at the same location, and the second video 113 is a video that is played back from right to left.

Referring to FIG. 8, the control module 400 may switch between playback of the first video 111 and playback of the second video 113 according to a specific signal input to the input module 300.

Switching between playback of the first video 111 and playback of the second video 113 may be performed at a point in time at which the specific signal (input signal) is input during playback and, when the video (111, 113) includes a location movement, the effect of allowing the user to go back may be provided.

The first video 111 and the second video 112, 113 may be coupled and stored in the storage module 100. The coupling may employ a method of storing under a name having the same identification symbol or mark and buffering may be minimized when switching between the first video and the second video by pre-loading the coupled second video or first video to a memory (not shown) or by preparing playback with a separate playback module (not shown) when the first video or the second video is played back.

In an example embodiment, each of the first video 111 and the second video 113 may be captured while moving at the same speed. In this case, it is easy to match the first video 111 to correspond to the second video 113 at the same location.

In an example embodiment, the first video 111 and the second video 113 may be captured at substantially the same moving speed in a direction (forward direction) and a reverse direction of the specific movement line. In this case, it is easy to match the first video 111 to correspond to the second video 113 at the same location.

In an example embodiment, referring to FIG. 7, video times of the first video 111 and the second video 113 may be converted to be substantially the same. Although capturing is performed while moving at substantially the same speed in the direction (forward direction) and the reverse direction of the specific movement line, an error may occur according to an environment or a speed. If the video times are converted to be the same, a travel distance is identical and the first video 111 and the second video 113 may be matched to correspond to the same location accordingly.

In an example embodiment, the first video 111 and the second video 113 may be matched at the same location in the specific movement line. For example, a video may include a tag at a location corresponding to a playtime and the first video 111 and the second video 113 may be switched at the same location by including the same tag at (substantially) the same location in the video.

In an example embodiment, the matching may be performed based on playtimes of the first video 111 and the second video 113. The first video 111 and the second video 113 may be captured while moving at substantially the same speed, or may be transformed to have the same video length. In this manner, a place may correspond to a playtime. Using this, the first video 111 and the second video 113 may be matched to each other at the same location based on the playtime. For example, if both the first video 111 and the second video 113 play back for 300 seconds, a location corresponding to x seconds in the first video 111 is substantially the same as a location corresponding to 300-x seconds in the second video 113. The present invention may provide the sense of reality as if the user goes back by matching the first video 111 and the second video 113 as described above and by playing back the second video 113 corresponding to the same location according to a specific input signal of the user during playback of the first video 111.

In detail, the control module 400 may switch between playback of the first video 111 and playback of the second video 113 at the matching same location according to the specific signal input to the input module 300.

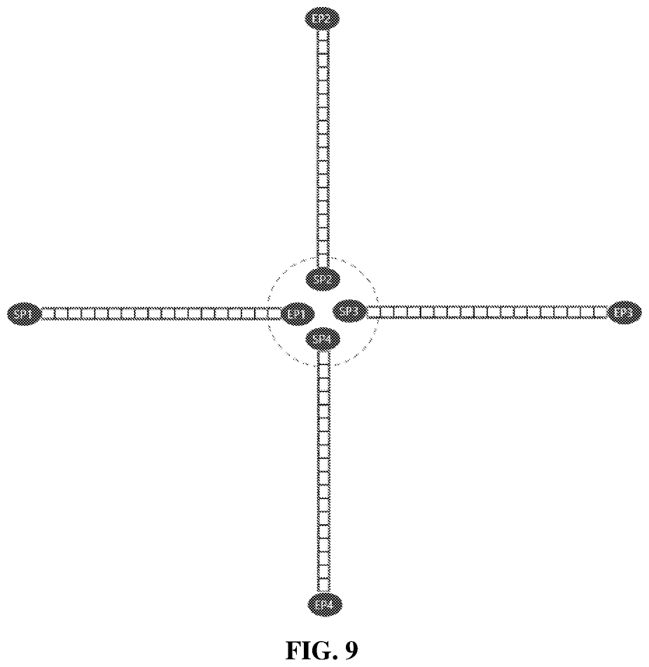

Referring to FIG. 9, the storage module 100 may store the video (110, 111, 112, 113) with start point and end point information of the specific movement line, the control module 400 may provide the user with information on a video of another specific movement line (from start point 2 (SP2) to end point 2 (EP2), from start point 3 (SP3) to end point 3 (EP3), from start point 4 (SP4) to end point 4 (EP4)) in which an end point (end point 1 (EP1) in FIG. 9) of the specific movement line (movement line from start point 1 to end point 1) is stored as a start point (SP2, SP3, SP4 in FIG. 9) after the video is displayed on the display module 200, and the control module 400 may play back the video of the other specific movement line (from SP2 to EP2, from SP3 to EP3, from SP4 to EP4) selected according to a selection signal of the user input to the input module 300, on the display module 200.

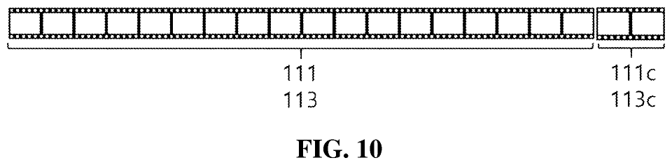

Referring to FIG. 10, in still another example embodiment, the video (110, 111, 112, 113) may further include an end point video captured at a specific time in place after moving along the specific movement line. In the case of content that provides a road view or a street view as VR/AR/MR, an amount of time may be used to select a next movement direction after playing back one video may be used (see FIG. 9). Here, if the video includes the end point video, a video with the sense of reality while staying at an end point without stopping may be provided to the user.

Here, the control module 400 controls the input module 300 to receive a direction selection signal for selecting a direction even during playback of the end point video. Although the entire end point video is not played back, the control module 400 may play back a video of another specific movement line selected according to a selection signal input to the input module 300, on the display module 200.

In an example embodiment, each of the first video 111 and the second video 113 may include at least two videos by changing at least one of weather, time, day and night, and moment, and videos having substantially the same weather, time, day and night, and moment may be coupled and stored in the storage module. This may have the effect of providing the user with various feelings of contents even in the same place.

### Video Playback Method

Another aspect of the present invention relates to a video playback method.

According to an example embodiment, the video playback method may include capturing the video 110 along a specific movement line and storing the video 110 in the storage module 100; playing back the video 110 on the display module 200; receiving a signal corresponding to a manipulation of a user using the input module 300; and switching the video between playback and reverse playback according to the signal.

According to another example embodiment, the video playback method may include capturing the first video 111 along a specific movement line and storing the first video 111 in the storage module 100; transforming the video to reversely play back and storing the same as the second video 112 in the storage module 100; playing back one of the first video 111 and the second video 112 on the display module 200; receiving a signal corresponding to a manipulation of a user using the input module 300; and switching between playback of the first video 111 and playback of the second video 112 according to the signal.

According to still another example embodiment, the video playback method may include capturing the first video 111 along a specific movement line and storing the first video 111 in the storage module 100; capturing the second video 113 in a reverse direction of the specific movement line and storing the second video 111 in the storage module 100; playing back one of the first video 111 and the second video 113 on the display module 200; receiving a signal corresponding to a manipulation of a user using the input module 300; and switching between playback of the first video 111 and playback of the second video 113 according to the signal.

At least one of the first video 111 and the second video 113 may further include an end point video captured at a specific time in place after moving along the specific movement direction or in the reverse direction of the specific movement direction.

Each of components of the video playback method according to another aspect of the present invention may be substantially the same as each of the components of the video playback system according to an aspect of the present invention.

Although a number of example embodiments of the present invention have been described above, the present invention may be provided in various forms without being limited to the example embodiments and it will be apparent to one of ordinary skill in the art that various alterations and modifications in form and details may be made in these example embodiments without changing the technical spirit and essential features of the present invention. Therefore, it should be understood that the example embodiments are illustrative in all respects and not limiting.

100: storage module 110: video 111: first video 111a: video before transformation 111b: video after transformation 111c: end point video 112, 113: second video 113c: end point video 200: display module 300: input module 400: control module

What is claimed is:

1. A video playback system comprising:
a storage module configured to store a video captured along a specific movement line;
a display module configured to display the video;
an input module configured to receive a signal corresponding to a manipulation of a user; and
a control module configured to play back the video on the display module in response to the signal input to the input module.

2. The video playback system of claim 1, wherein the video is a video captured with a 360° camera.

3. The video playback system of claim 1, wherein the control module switches between playback and reverse playback according to a specific signal input to the input module.

4. The video playback system of claim 1, wherein the video includes a first video and a second video,
the second video is a reverse playback video of the first video, and
the control module is configured to switch between playback of the first video and playback of the second video according to a specific signal input to the input module.

5. The video playback system of claim 4, wherein the first video and the second video are coupled and stored in the storage module.

6. A video playback method comprising:
capturing a video along a specific movement line and storing the video in a storage module;
playing back the video on a display module;
receiving a signal corresponding to a manipulation of a user using an input module; and
switching the video between playback and reverse playback according to the signal.
